(19) United States
(12) Patent Application Publication
(10) Pub. No.: US 2026/0017222 A1
(43) Pub. Date: Jan. 15, 2026

(54) CONTROLLERS, HOSTS, METHODS OF OPERATING CONTROLLERS, AND METHODS OF OPERATING HOSTS

(71) Applicant: YANGTZE MEMORY TECHNOLOGIES CO., LTD., Wuhan (CN)

(72) Inventors: Juan LI, Wuhan (CN); Jianbo TENG, Wuhan (CN); Lei REN, Wuhan (CN)

(21) Appl. No.: 19/011,271

(22) Filed: Jan. 6, 2025

(30) Foreign Application Priority Data
Jul. 9, 2024 (CN) 2024109185505

(51) Int. Cl. G06F 13/42

(52) U.S. Cl. CPC G06F 13/4221; G06F 2213/0026

(57) ABSTRACT

The present disclosure provides controllers, hosts, methods of operating a controller, and methods of operating a host. An example controller includes a controller processor, an interface circuit and a buffer. The interface circuit is coupled to the buffer. Wherein the buffer is configured to buffer log information generated during the running of the firmware by the controller processor. The interface circuit is configured to: obtain the log information generated during the running of the firmware from the buffer, output the log information to a host.

### CROSS-REFERENCE TO RELATED APPLICATIONS

The present application claims the benefit of priority to China Application No. 202410918550.5, filed on Jul. 9, 2024, the content of which is incorporated herein by reference in its entirety.

### TECHNICAL FIELD

The present disclosure relates to the field of semiconductor technology, and in particular to a controller, a host, a method of operating a controller, and a method of operating a host.

### BACKGROUND

Firmware (FW) is a program code embedded in a Solid-State Drive (SSD), which controls the basic functions of the SSD and the interaction with the host. To ensure that the SSD can run stably, reliably, and efficiently, debugging the SSD FW is a crucial step. During the debugging of the SSD FW, it is necessary to record a large amount of log information generated by the firmware operation on the input/output (I/O) path, and then output the log information through the serial port to reproduce and locate the problem. However, outputting log information through the serial port will significantly reduce I/O performance, which may make timing-related problems difficult to be reproduced.

### SUMMARY

Examples of the present disclosure provide a controller, a host, a method of operating a controller, and a method of operating a host, to output log information without affecting I/O performance.

Some examples of the present disclosure employ the following technical solutions:

In a first aspect, an example of the present disclosure provides a controller, the controller includes an interface circuit and a buffer. The interface circuit is coupled to the buffer. Wherein the buffer is configured to buffer log information generated during the running of the firmware. The interface circuit is configured to: obtain the log information generated during the running of the firmware from the buffer, output the log information.

In some implementations, the interface circuit includes a Peripheral Component Interconnect Express (PCIe).

In some implementations, the buffer includes at least one of a volatile memory device and a non-volatile memory device.

In some implementations, the buffer includes at least one of a controller memory buffer (CMB) and a persistent memory region (PMR).

In some implementations, the CMB and the PMR are direct memory access regions.

In some implementations, the controller includes multiple cores. The multiple cores are respectively coupled to the buffer. The multiple cores are configured to buffer the log information generated during the running of the firmware to the buffer.

In some implementations, the different cores correspond to different memory regions in the buffer. The multiple cores are configured to buffer the log information generated during the running of the firmware to the corresponding memory region.

In some implementations, the buffer includes a plurality of memory addresses, and the memory addresses are to indicate locations for writing and reading the log information. At a same time instance, a same memory address is for at most one of writing the log information and reading the log information.

In some implementations, the controller further includes a controller processor. The controller processor is coupled to the interface circuit and the buffer. The controller processor is configured to: output a control instruction in response to a received log extraction request. The log extraction request includes information for a preset quantity of log information to be extracted. The control instruction is to control the buffer to output log information with a quantity being less than or equal to a preset quantity.

In some implementations, the log information includes identification information and log data information. The identification information is to indicate bits occupied by the log data.

In a second aspect, an example of the present disclosure provides a host, the host including a host processor and a memory device. The host processor is coupled to the memory device. The host is coupled to a controller. The host processor is configured to: obtain log information from a buffer of the controller according to a target address, the target address is a memory address of the log information in the buffer, store the log information in the memory device.

In some implementations, the log information includes identification information and log data information. The identification information is to indicate bits occupied by the log data. The host processor is further configured to: obtain log data according to the identification information and the log data information.

In some implementations, the buffer includes at least one of a CMB and a PMR.

In some implementations, the CMB and the PMR are direct memory access regions.

In a third aspect, an example of the present application provides a method of operating a controller, the method of operating a controller includes: obtaining the log information generated during the running of the firmware from the buffer, wherein the log information generated during the running of the firmware is buffered to the buffer of the controller, outputting the log information.

In some implementations, the controller includes multiple cores. The method of operating a controller further includes: buffering, by the multiple cores, the log information generated during the running of the firmware to the buffer.

In some implementations, the different cores correspond to different memory regions in the buffer. The buffering, by the multiple cores, the log information generated during the running of the firmware to the buffer includes: buffering, by the multiple cores, the log information generated during the running of the firmware to the corresponding memory region.

In some implementations, the buffer includes a plurality of memory addresses, and the memory addresses are to indicate locations for writing or reading the log information. At a same time instance, a same memory address is only for writing or reading the log information.

In some implementations, the method further includes: outputting a control instruction in response to a received log extraction request. The log extraction request includes information for a preset quantity of log information to be extracted. The control instruction is to control the buffer to output log information with a quantity being less than or equal to a preset quantity.

In some implementations, the log information includes identification information and log data information. The identification information is to indicate bits occupied by the log data.

In a fourth aspect, an example of the present disclosure provides a method of operating a host, including: obtaining log information from a buffer of the controller according to a target address, where the target address is a memory address of the log information in the buffer, storing the log information in the memory device.

In some implementations, the log information includes identification information and log data information. The identification information is to indicate bits occupied by the log data. The method of operating a host further includes: obtaining log data according to the identification information and the log data information.

In a fifth aspect, an example of the present disclosure provides a memory system including a memory device and any controller of the first aspect. The controller is coupled to the memory device.

In a sixth aspect, an example of the present disclosure provides a system including a server and a memory system of the fifth aspect. The server is coupled to the memory system.

In some implementations, the server includes a cloud server.

In a seventh aspect, an example of the present disclosure provides an electronic device including any controller of the first aspect and any host of the second aspect. The host is coupled to the controller.

In an eighth aspect, an example of the present disclosure provides a computer-readable storage medium including instructions. The instructions, when executed on the processor, cause the processor to execute any of the method of operating a controller of the third aspect and/or the method of operating a host of the fourth aspect.

### BRIEF DESCRIPTION OF THE DRAWINGS

In order to illustrate the technical solutions in the present disclosure more clearly, the following will briefly introduce the accompanying drawings used in some examples of the present disclosure, apparently, the accompanying drawings in the following description are only drawings of some examples of the present disclosure, and those skilled in the art can also obtain other drawings according to these accompanying drawings. In addition, the accompanying drawings in the following description may be regarded as schematic diagrams, and are not limitations on the actual size of the product involved in the examples of the present disclosure, actual flows of methods, actual timings of signals, etc.

FIG. 1 is a module schematic diagram 1 of an electronic device according to some examples.

FIG. 2 is a module schematic diagram 2 of an electronic device according to some examples.

FIG. 3 is a module schematic diagram 3 of an electronic device according to some examples.

FIG. 4 is a module schematic diagram 4 of an electronic device according to some examples.

FIG. 5 is a schematic diagram of a PCIe layered structure according to some examples.

FIG. 6 is a schematic diagram of a structural relationship between NVMe and PCIe according to some examples.

FIG. 7 is a schematic diagram of a queue structure according to some examples.

FIG. 8 is a schematic diagram of a queue producer/consumer model according to some examples.

FIG. 9 is a schematic diagram 1 of command execution of a queue in an electronic device according to some examples.

FIG. 10 is a schematic diagram 2 of command execution of a queue in an electronic device according to some examples.

FIG. 11 is a schematic diagram 3 of command execution of a queue in an electronic device according to some examples.

FIG. 12 is a schematic diagram 4 of command execution of a queue in an electronic device according to some examples.

FIG. 13 is a schematic diagram 5 of command execution of a queue in an electronic device according to some examples.

FIG. 14 is a module schematic diagram 5 of an electronic device according to some examples.

FIG. 15 is a module schematic diagram 6 of an electronic device according to some examples.

FIG. 16 is a module schematic diagram 7 of an electronic device according to some examples.

FIG. 17 is a module schematic diagram 8 of an electronic device according to some examples.

FIG. 18 is a module schematic diagram 9 of an electronic device according to some examples.

FIG. 19 is a schematic diagram of a ring buffer structure according to some examples.

FIG. 20 is a module schematic diagram 10 of an electronic device according to some examples.

FIG. 21 is a schematic diagram of a log information organization method according to some examples.

FIG. 22 is a schematic diagram of a system module according to some examples.

FIG. 23 is a schematic flowchart 1 of an operating method according to some examples.

FIG. 24 is a schematic flowchart 2 of an operating method according to some examples.

FIG. 25 is a module schematic diagram of a memory card according to some examples.

FIG. 26 is a module schematic diagram of a solid-state drive according to some examples.

FIG. 27 is a module schematic diagram 1 of a memory module according to some examples.

FIG. 28 is a module schematic diagram 2 of a memory module according to some examples.

### DETAILED DESCRIPTION

The technical solutions in some examples of the present disclosure will be clearly and completely described below in conjunction with the accompanying drawings, apparently, the described examples are only some, not all of examples of the present disclosure. All other examples obtained by those skilled in the art based on the examples provided in the present disclosure belong to the claimed scope of the present disclosure.

Unless the context requires otherwise, throughout the description and claims, the term “comprising” is interpreted as open and inclusive, e.g., “including, but not limited to”. In the description of the present disclosure, the terms “one example”, “some examples”, “exemplary example”, “exemplarily” or “some examples” are intended to indicate that a particular feature, structure, material, or characteristic related to the example or example is included in at least one example or example of the present disclosure. Illustrative representations of the terms described above are not necessarily referring to a same example. Furthermore, particular feature, structure, material or characteristic described above may be included in any suitable manner in any one or more examples or examples.

Hereinafter, the terms “first” and “second” are used for descriptive purposes only, and should not be understood as indicating or implying relative importance or implicitly specifying the quantity of indicated technical features. Thus, a feature defined as “first” and “second” may explicitly or implicitly include one or more of these features. In the description of examples of the present disclosure, “plurality” means two or more, unless specified otherwise.

In describing some examples, the expressions “coupled” and “connected” and their derivatives may be used. For example, in describing some examples, the term “connected” may be used to indicate that two or more elements are in direct physical or electrical contact with each other. As another example, in describing some examples, the term “coupled” may be used to indicate that two or more elements are in direct physical or electrical contact. However, the term “coupled” may also mean that two or more elements are not in direct contact with each other, but yet still co-operate or interact with each other. Examples disclosed herein are not necessarily limited by the context herein.

“At least one of A, B and C” has the same meaning as “at least one of A, B or C” and both include the following combinations of A, B and C: only A; only B; only C; combination of A and B; combination of A and C; combination of B and C; and combination of A, B and C.

“A and/or B” includes the following three combinations: only A; only B; only C; and combination of A and B.

The use of “suitable for” or “configured to” herein means open and inclusive language that does not exclude devices that are suitable for or configured to perform additional tasks or steps.

Additionally, the use of “based on” is meant to be open and inclusive, as a process, step, calculation, or other action that is “based on” one or more stated conditions or values may in practice be based on additional conditions or beyond stated values.

Firmware (FW) is a program code embedded in a memory system (e.g., a Solid-State Drive (SSD)), which controls the basic functions of the memory system and the interaction with external devices (e.g., the host of an electronic device). To ensure that the memory system can operate stably, reliably and efficiently, debugging the FW in the memory system is a crucial step. In the process of debugging the FW of the memory system, it is necessary to record a large amount of log data generated by the FW operation on the input/output (I/O) path (the I/O path refers to the entire process from data request generation to the final data being written or read into the memory system) to reproduce and locate the problem.

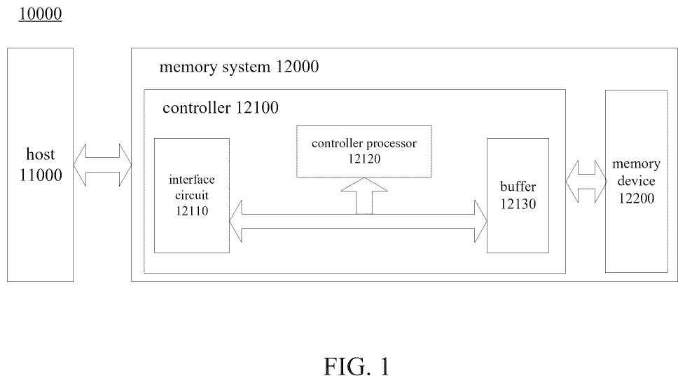

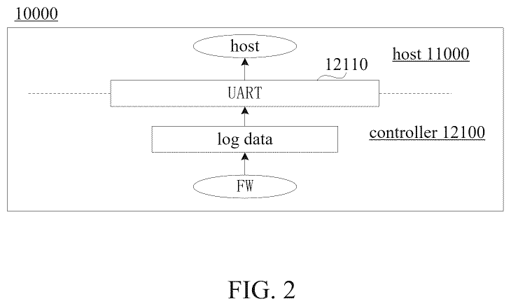

In order to save the log data generated by the FW operation for problem reproduction and location, an example of the present disclosure provides an electronic device 10000. As shown in FIG. 1, the electronic device 10000 includes a host 11000 and a memory system 12000, and the host 11000 is coupled to the memory system 12000. The memory system 12000 includes a controller 12100 and a memory device 12200, and the controller 12100 is coupled to the memory device 12200. The controller 12100 includes an interface circuit 12110, a controller processor 12120 and a buffer 12130, and the interface circuit 12110 (e.g., an I/O interface), the controller processor 12120 and the buffer 12130 are coupled to each other. The interface circuit 12110 may employ a serial transmission method of data transmission, and for the sake of simple, stable and low power data transmission, the interface circuit 12110 may employ a Universal Asynchronous Receiver/Transmitter (UART) to implement serial communication between devices. As shown in FIG. 2, the FW generates log data during operation, and then actively transmits it to the host 11000 for storage or analysis in real time through the interface circuit 12110, e.g., UART.

In the implementation as shown in FIG. 2, the serial port transmission rate (e.g., the common 115200 bps) is much lower than the random read and write performance of the memory system 12000 (e.g., several hundred KIOPS), where IOPS represents the number of Input/Output Operations Per Second (IOPS). This means that when a large amount of log data is actively output through the serial port in real time, a large amount of controller processor 12120 resources and system time will be occupied, resulting in a significant decrease in the serial port performance of the interface circuit 12110 of the memory system 12000. For example, it causes problems such as slow system response, slow data transmission speed, and application freezes. The serial port performance of the interface circuit 12110 of the memory system 12000 may be reduced, because the log information is actively in substantially real-time output through the interface circuit 12110 at the low serial port transmission rate and with the mismatch with the random read and write rate of the memory system 12000.

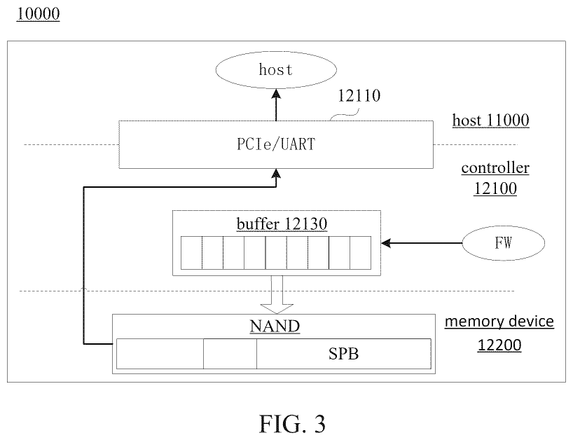

In some implementations, the log data may be temporarily stored in the memory device 12200. As shown in FIG. 3, the FW will generate a series of log data, which may contain detailed information about the operation, errors, performance, etc. of the memory system 12000. In some scenarios, since the log data may grow rapidly and the amount is large, and the speed of writing to the memory device 12200 is slow, the log data may be buffered in the buffer 12130 first, and then written from the buffer 12130 to the memory device 12200, e.g., NAND's SPB (Super Block, a way to manage Block in NAND, the capacity of an SPB is about tens of gigabytes), to ensure the integrity of the log data and improve the efficiency of log data transmission. When a problem or anomaly occurs in the memory system 12000, it is necessary to view the log data temporarily stored in the memory device 12200 to diagnose the problem. The host 11000 may export the log data from the memory device 12200 through the interface circuit 12110 for analysis. The interface circuit 12110 may include but is not limited to UART, and may also include a high-speed serial computer expansion bus standard (Peripheral Component Interconnect Express, PCIe) interface, etc., which is not limited here.

In some examples, taking the interface circuit 12110 including UART as an example, the host 11000 may trigger the export operation of log data through the UART command.

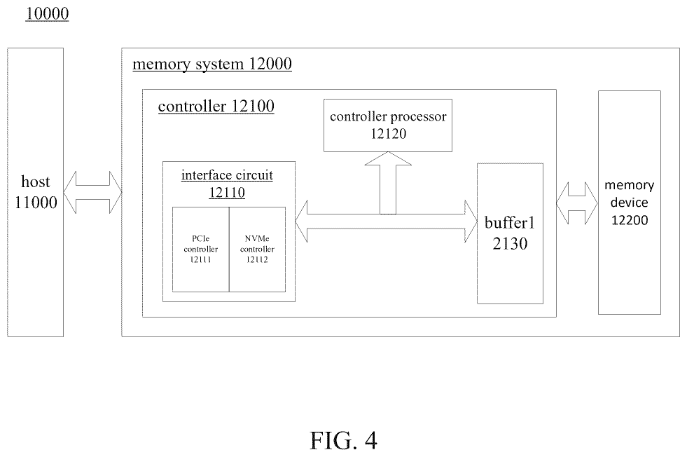

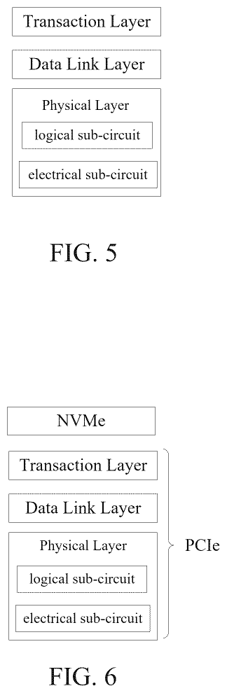

In other examples, taking the interface circuit 12110 including a PCIe interface as an example, as shown in FIG. 4, the interface circuit 12110 may include a PCIe controller 12111 and a Non-Volatile Memory Express (NVMe) controller 12112. NVMe is a non-volatile memory host controller interface specification that provides a communication interface for various Non-Volatile Memory (NVM) systems, such as Solid-State Drive (SSD), flash memory, and Storage Class Memory (SCM). Among them, PCIe, as a high-speed serial computer expansion bus standard, has its main advantages of high-speed data transmission capability and flexibility and it connects the host 11000 and the memory system 12000 in the electronic device. Commands and data are transmitted between the host 11000 and the memory system 12000 through the front-end bus of the PCIe interface. As shown in FIG. 5, PCIe adopts a layered implementation architecture, including a Transaction Layer, a Data Link Layer, and a Physical Layer, where the physical layer includes a logical sub-circuit and an electrical sub-circuit. Each layer has its specific functions, but in general, the lower layer provides services for the upper layer.

The NVMe protocol runs on the PCIe bus, as shown in FIG. 6, and its architecture is located above PCIe. Therefore, NVMe devices (e.g., NVMe SSDs) need to use the PCIe interface to communicate with the host system. The NVMe protocol defines the command set for communication between the host 11000 and the NVMe device and the execution method of the command. In some examples, taking the NVMe device being the memory system 12000 as an example, NVMe contains two types of main commands: Admin command and I/O command. An Admin command is to help the host 11000 manage and control the memory system 12000, while an I/O command is to transfer data between the host 11000 and the memory system 12000.

In some implementations, NVMe completes communication with the host 11000 through the Submission Queue (SQ), Completion Queue (CQ) and Doorbell Register (DB). SQ is located in the memory device of the host 11000, when the host 11000 wants to send a command, it first puts the prepared command in the SQ and then notifies the memory system 12000 to fetch it. CQ is also located in the memory device of the host 11000, when the execution of a command is completed, whether it succeeds or fails, the memory system 12000 will always write the command completion status to the CQ. The host 11000 informs the memory system 12000 by writing the DB register on the memory system 12000 side. The relationship between SQ and CQ may be one-to-one or many-to-one, but in any case, they are paired. For example, there must be a CQ if there is a SQ. Admin SQ/CQ and I/O SQ/CQ each have their own functions, an Admin command cannot be placed in I/O SQ, and an I/O command cannot be placed in Admin CQ either. I/O SQ/CQ is created through an Admin command, and there is only one pair of Admin SQ/CQ in the host 11000, and they are in a one-to-one relationship, while there are multiple pairs of I/O SQ/CQ.

Both SQ and CQ have a queue structure, and logically they are both a ring queue structure. SQ is to store multiple Submission Queue Entries (SQE. For example, SQE is the basic component unit of SQ, SQ is composed of multiple SQEs, and in the NVMe protocol, each I/O SQ (submission queue for executing I/O commands) corresponds to a set of SQEs. When the host 11000 needs to issue an I/O command, it will write the SQE containing the command information into the SQ. The host 11000 may issue an I/O command by writing the SQE into the SQ. In the NVMe protocol, SQE is the basic unit for submitting an I/O request. It contains all the information required to perform an I/O operation, e.g., data address, length, command type, etc. Similarly, CQ is to store multiple Completion Queue Entries (CQE). When the host 11000 submits I/O commands to the NVMe device, these commands will be placed in the SQ. Once the NVMe device has processed the commands, it generates corresponding CQEs in the CQ to notify the host 11000 of the completion status of the commands. CQE is the basic component unit of CQ. CQ is composed of multiple CQEs, each of which corresponds to a completed I/O command. CQE is the smallest unit used to store I/O command completion information in the NVMe protocol. It contains the status, results and other related information about a completed I/O command.

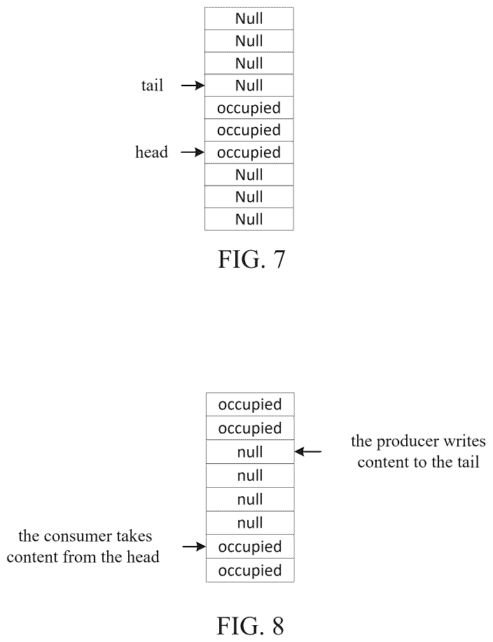

As shown in FIG. 7, the queue has several elements, in addition to the queue depth and queue content, there are also the head and tail of the queue. The head of the queue indicates that it is being served or waiting to be served, and once its service is completed, it will leave the queue. It can be seen that the head and tail of the queue are very important, the head determines which will be served immediately, and the tail determines the new write position. DB is to record the head and tail of a SQ or CQ. Each SQ or CQ has two corresponding DBs, including the head DB (Head DB) and the tail DB (Tail DB). DB is a register at the memory system 12000 side, which records the positions of the head and tail of SQ and CQ.

As shown in FIG. 8, this is a queue producer/consumer model. The producer writes content to the tail of the queue, and the consumer takes content from the head of the queue. For an SQ, its producer is the host 11000, because it writes commands to the tail of the SQ, and the consumer is the memory system 12000, because it removes instructions from the head of the SQ and executes them. For a CQ, at the opposite side, the producer is the memory system 12000, because it writes command completion information to the tail of the CQ, and the consumer is the host 11000, which fetches command completion information from the head of the CQ.

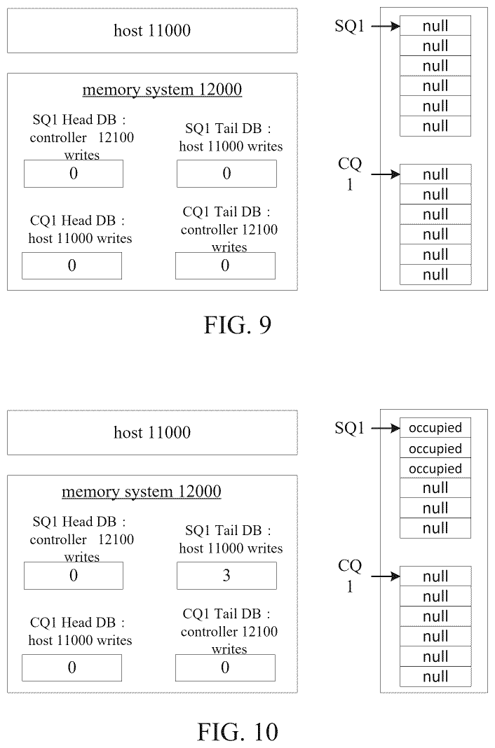

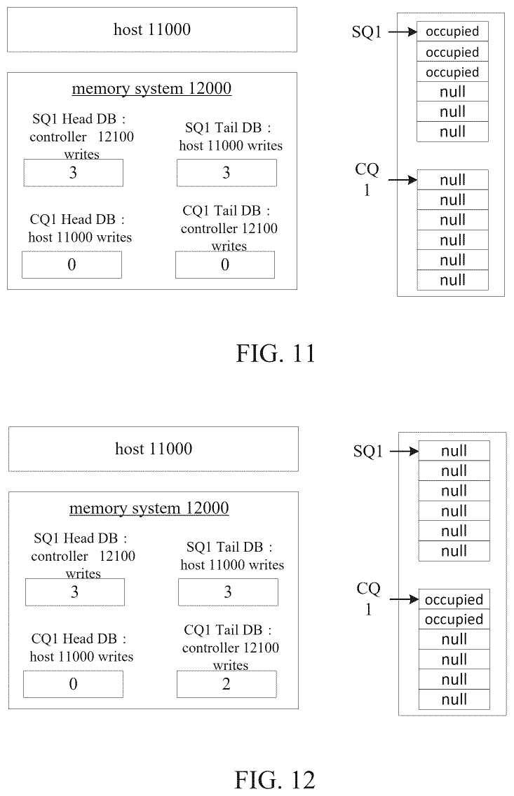

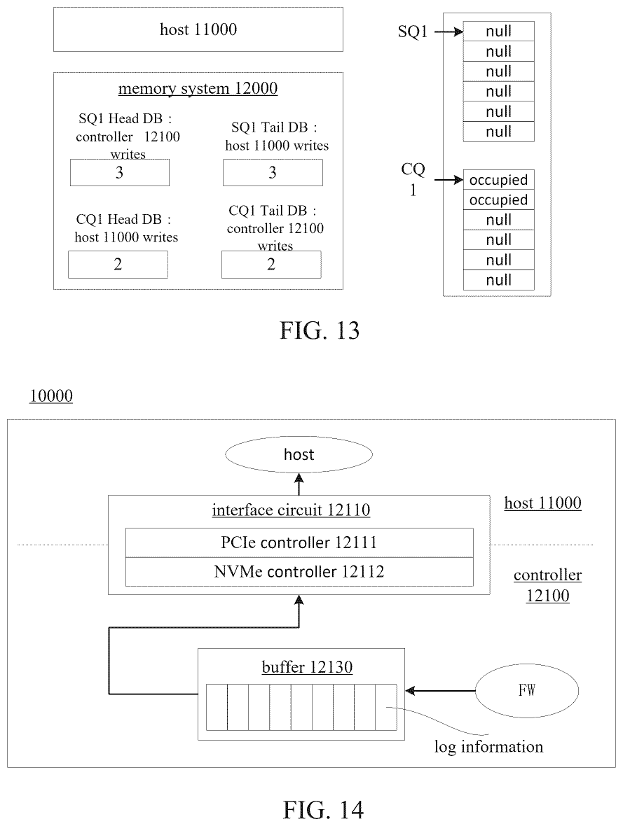

In an example, as shown in FIG. 9, in the initialization state, SQ1 and CQ1 are empty, and Head=Tail=0. As shown in FIG. 10, the host 11000 writes 3 commands to SQ1, and the Tail of SQ1 becomes 3. After the host 11000 writes 3 commands to SQ1, the value of the SQ1 Tail DB register on the controller 12100 is updated to 3. When the host 11000 updates this register, it is also telling the controller 12100 that there is a new command to fetch and execute. As shown in FIG. 11, after receiving the notification, the controller 12100 goes to SQ1 to fetch all three commands for execution. The memory system 12000 consumes all three commands of SQ1, and the Head of SQ1 is also adjusted to 3, and the controller 12100 will write this Head value to the local SQ1 Head DB register. As shown in FIG. 12, the memory system 12000 executes two commands, so it writes two command completion information to CQ1 and updates the value of the Tail DB register corresponding to CQ1 to 2. Meanwhile, a message is sent to the host 11000. As shown in FIG. 13, the host 11000 receives the notification (interrupt information) from the memory system 12000 and fetches 2 completion information from CQ1. After processing, the host 11000 updates the Head value of CQ1 in the CQ1 Head DB register to 2.

In the command processing flow, the DB records the head and tail of SQ and CQ. For SQ, the memory system 12000 is a consumer, which directly deals with the head of the queue and knows where the head of SQ is, therefore the SQ Head DB is maintained by the memory system 12000 itself. However, it does not know how long the queue is, where the tail is, and how many commands are waiting to be executed, on the contrary, the host 11000 knows these, thus the SQ Tail DB is updated by the host 11000. The memory system 12000 combines the head and tail of SQ to know how many commands are waiting to be executed in SQ. For CQ, the memory system 12000 is the producer, which knows where the tail of CQ is, thus CQ Tail DB is updated by itself, however, the memory system 12000 does not know how many command completion information the host 11000 has processed, which requires the host 11000 to inform, thus the CQ Head DB is updated by the host 11000. The memory system 12000 knows whether CQ can still be processed and how many command completion information it may accept according to the head and tail of CQ. DB also plays a notification role, when the host 11000 is updating SQ Tail DB, meanwhile it is also informing the memory system 12000 that there are new commands to be processed. When the host 11000 is updating CQ Head DB, meanwhile it is also informing the memory system 12000 that the returned command completion status information has been processed.

The NVMe protocol allows users to configure some commands according to the actual application scenario needs to meet the needs of some scenarios. For example, in this implementation, the host 11000 may trigger the export operation of log data through the NVMe-based Vendor Unique (VU) command. NVMe VU Command is an optional feature in the NVMe protocol, which gives the manufacturer of the electronic device 10000 the ability to define a unique command set for its memory system 12000, which is sent through SQ and the result is returned through CQ. The way and process of their execution in the NVMe device are similar to standard commands, but the content and behavior are defined by the manufacturer. This mechanism allows device manufacturers to customize the functions of their devices to distinguish them from SSDs that only use the standard NVMe command set. Almost all NVMe controllers support this VU Command mechanism, which means that the use of NVMe VU Command has a wide range of applicability in terms of hardware compatibility. Device manufacturers can use NVMe VU Command to expand the functions of the memory system to meet their needs or application scenarios. For example, some advanced features, performance optimizations, or management functions may be implemented only through these unique commands. The format and definition of the VU Command is entirely up to the device manufacturer and is detailed in the NVMe specification of its device. These commands generally follow the basic structure and syntax of the NVMe command set, but may contain additional fields or parameters to implement functions. From the perspective of the host 11000, the implementation of exporting log data using the NVMe VU Command is relatively simple, which only requires adding a new NVMe VU Command in the FW, because this process does not require special hardware support or specific memory regions. This flexibility enables device manufacturers to easily expand and customize the functionality of their memory systems through software updates. Once the memory system 12000 receives the export command, the memory system 12000 FW reads the log data temporarily stored in the memory device 12200 and sends it to the host 11000 for storage or parsing.

In some examples, since the capacity of the memory device 12200 is limited and the log data may grow rapidly, the firmware may compress the log data before storing it into the memory device 12200 to reduce the use of storage space in the memory device 12200 and improve the utilization efficiency of the storage space. The compressed log data will be temporarily stored in the memory device 12200, waiting for subsequent export and save or export analysis. When the memory system 12000 is faulty or abnormal, the developer or technical support personnel may need to view these temporarily stored logs to diagnose the problem.

In the examples shown in FIGS. 3 and 4, a strategy of temporarily storing the log data in the memory device 12200 may be adopted in the log data processing mechanism of the memory system 12000. This design triggers the export operation of log data through UART commands or NVMe VU Commands, aiming to avoid the performance overhead caused by serial communication, and avoiding the mismatch between its low transmission rate and the high random read and write rate of the memory system 12000 through reducing the real-time requirements of serial communication, thereby preventing the interface circuit 12110 performance from being significantly reduced due to the serial port performance bottleneck. In addition, this strategy also ensures that the actual performance of the memory system 12000 will not be significantly obscured or changed during the debugging process due to the additional delay of serial port communication and the increased load of the controller processor 12120, which may be important for debugging serial port performance-sensitive issues, and avoids the technical problem that performance-sensitive issues cannot be reproduced. However, the limited capacity of the memory device 12200 (the capacity of an SPB is about tens of gigabytes) has become a challenge. In a long-term or high-intensity test environment, the rapid accumulation of log data may quickly exhaust its storage space, thereby affecting the normal operation of the memory system 12000. Meanwhile, the limited storage space limits the storage time of the log data (e.g., the memory device 12200 may be filled up in about two hours), especially when it is necessary to trace a long-term anomaly, the development process of the problem may not be fully presented due to data truncation, which brings difficulties to problem tracing, locating and solving.

In order to be able to quickly store a large amount of log data, in some implementations, compared with the implementation shown in FIG. 4, as shown in FIG. 14, the log data (the log information in FIG. 14 includes the log data) generated by the controller 12100 running the FW may be temporarily stored in the buffer 12130. For example, the log data generated by the FW is neither directly and actively transmitted to the host 11000 through the interface circuit 12110 according to the implementation shown in FIG. 2, nor is it temporarily stored in the memory device 12200 according to the implementation shown in FIGS. 3 and 4. The host 11000 may trigger the export operation of log data through NVMe VU Command, and export the log data from the buffer 12130 to the host 11000 through the interface circuit 12110 (including the PCIe controller 12111 and the NVMe controller 12112) for storage or parsing.

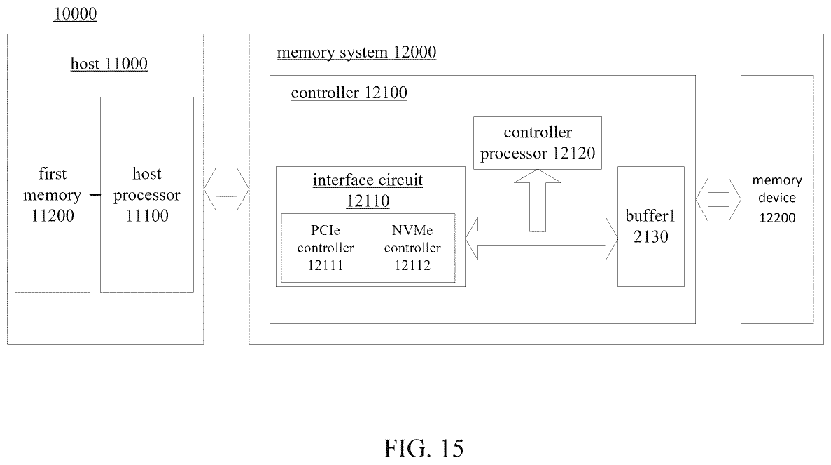

In some examples, as shown in FIG. 15, the host 11000 includes a host processor 11100 and a first memory 11200. The host 11000 also includes an interface circuit (not shown in FIG. 15) which matches with the interface circuit 12110 in the memory system 12000. The host processor 11100 is coupled to the first memory 11200. The host processor 11100 triggers the export operation of log data or the log extraction request through NVMe VU Command, and the log extraction request includes information for a preset quantity (e.g., all or part) of the log information to be extracted. In response to the received log extraction request, the controller processor 12120 outputs a control instruction to the buffer 12130, the control instruction is to control the buffer 12130 to output log information with a quantity being less than or equal to a preset quantity. Then the host 11000 obtains the log data from the buffer 12130 of the controller 12100, and stores the log data in the first memory 11200, so as to achieve the purpose of long-term preservation of the log data for subsequent analysis and diagnosis. The first memory 11200 may include but is not limited to a hard disk (e.g., a mechanical hard disk and a solid-state hard disk), a network disk and a cloud disk, or may be any physical device or virtual device with a data storage function, which is not limited here.

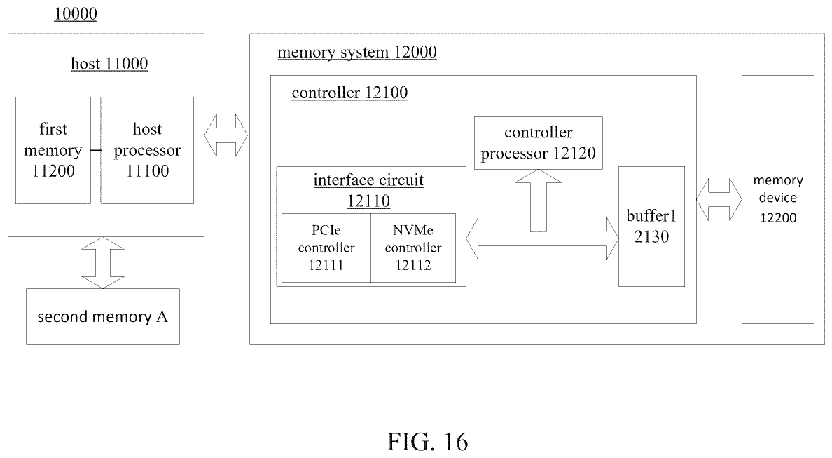

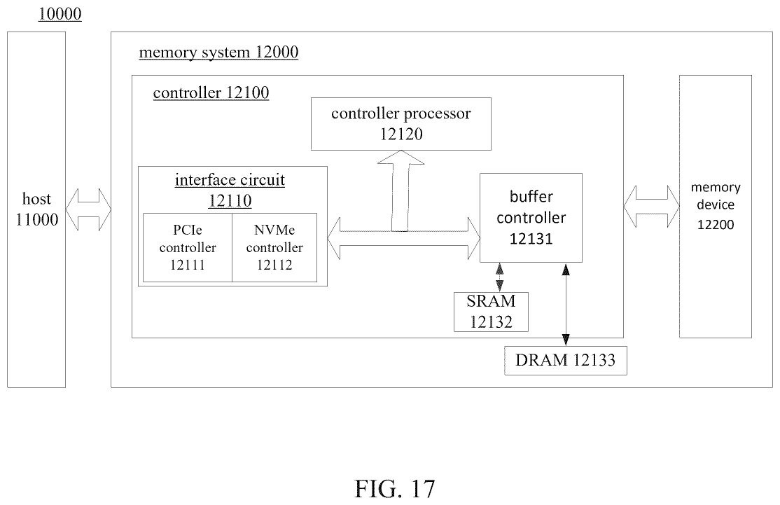

For example, as shown in FIG. 16, at least one second memory A may be further provided external to the host 11000, and the second memory A is similar to the first memory 11200, and may further increase the storage space of the buffered log data.

In some examples, the buffer 12130 may include, but is not limited to, at least one of the following: volatile memories such as Static Random-Access Memory (SRAM) and Dynamic Random-Access Memory (DRAM); and SCM, such as Phase-Change Memory (PCM), Ferroelectric Random Access Memory (FeRAM); and non-volatile memories such as NAND, without limitation here. For example, the controller 12100 may choose to use SRAM or DRAM according to the storage speed and size requirements, SRAM is usually faster than DRAM, but it is also more expensive and has a smaller capacity. DRAM has a higher capacity and a lower cost. If a large amount of data needs to be written quickly, SRAM may be used. If a large amount of data needs to be stored for a long time, DRAM may be used. As shown in FIG. 17, the buffer 12130 includes a buffer controller 12131, an SRAM 12132, and a DRAM 12133.

In the implementation shown in FIG. 14, although the implementation of the NVMe VU Command is relatively simple, because the NVMe VU Command requires the FW to parse and implement the command, the FW still needs to perform some additional processing, which may increase some additional processing time and performance overhead.

In order to further improve the rate of storing a large amount of log data, the memory system 12000 may perform the following optimization configuration through its controller 12100: the controller 12100 may configure part or all of the general buffer of buffer 12130 within the memory system 12000 as a Controller Memory Buffer (CMB) and/or a Persistent Memory Region (PMR), and map these resources to the host 11000, thereby allowing the host 11000 to use these CMBs or PMRs to buffer log data.

In an implementation, in the NVMe protocol, the controller 12100 is allowed to map the general buffer region inside the memory system 12000 to the host 11000, so that the host 11000 can access the general buffer region through PCIe memory read/write (a form of data transmission based on the PCIe bus). For example, the general buffer region (e.g., DRAM) of the internal buffer 12130 of the memory system 12000 is configured as CMB and/or PMR for use by the host 11000, the CMB (or PMR) may be used to store various NVMe queues (such as SQ and CQ), and may also be used to store NVMe data (e.g., log data), etc. The way that SQ and CQ established in the CMB and PMR use a queue is the same as the way that SQ and CQ established in the memory device of the host 11000 use a queue.

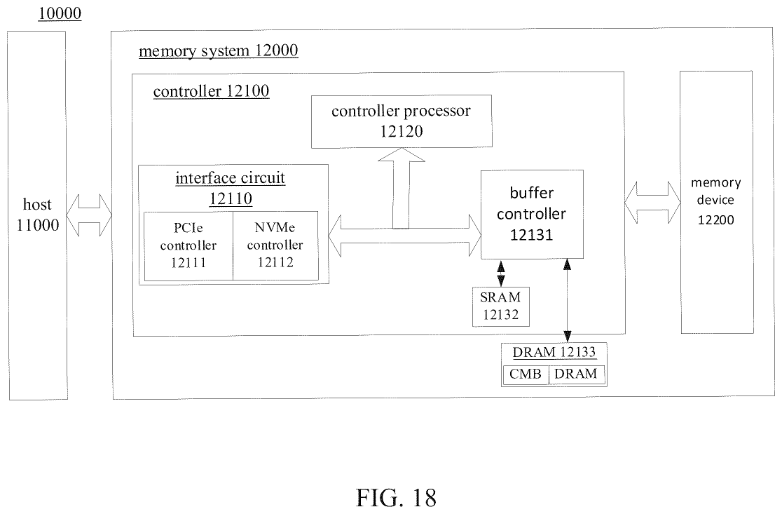

In some examples, NVMe SQ and CQ being established on CMB is taken as an example. Some general buffer regions of the internal buffer 12130 (e.g., DRAM or SRAM) of the memory system 12000 are configured as CMB. As shown in FIG. 18, some general buffer regions of the DRAM inside the memory system 12000 are configured as a CMB. CMB is an important feature in the NVMe protocol, which significantly improves the efficiency and performance of data transmission by establishing the NVMe submission queue (SQ) on the CMB. Under the CMB architecture, the SQ and CQ required for NVMe to transmit I/O commands may reside directly in the general buffer region (e.g., DRAM) of the internal buffer 12130 of the memory system 12000, rather than in the memory device of the host 11000. Such a design reduces the command interaction delay between the host 11000 and the memory system 12000, because the host 11000 does not need to pass through the PCIe bus when writing the SQ entry (SQE). Through the CMB, the controller 12100 can map the general buffer inside the memory system 12000 to the address space of the host 11000. Once the mapping is completed, the host 11000 can directly perform the read and write on the CMB inside the controller 12100 through the PCIe interface just like accessing its own memory device. Since CMB allows direct access, this mechanism avoids the data transmission bottleneck based on the PCIe bus (e.g., bus bandwidth limitation, although the PCIe bus provides a high-speed data transmission capability, its bandwidth is still limited), thereby significantly reducing the delay of data transmission. Direct access to the memory device of the host 11000 or the memory device inside the controller 12100 greatly improves the efficiency of data transmission and further improves the overall performance of the memory device. The CMB feature not only optimizes the delay of data transmission, but also enhances the response speed and throughput of the memory system 12000. At the same time, the direct access to the memory device inside the controller 12100 can greatly improve the efficiency of data transmission, thereby improving the overall performance of the memory device.

Since the CMB function needs to be supported at the hardware level of the controller 12100, therefore not all memory systems 12000 have this function, and only those memory systems 12000 whose controllers 12100 are designed to support CMB can use it. Therefore, in some implementations, the controller 12100 has two registers, Controller Memory Buffer Location (CMBLOC) and Controller Memory Buffer Size (CMBSZ), to describe the basic information for CMB, including its location and size. The host 11000 uses CMB by enabling the CMBLOC and CMBSZ registers. CMBSZ is read-only for the host 11000. It determines the size of the internal buffer of the memory system 12000 that can be used for CMB, as well as the minimum granularity, where Size refers to the length of the available space in CMB. CMBSZ is to indicate whether to support the establishment of SQ and CQ in CMB, and when initializing CMB, FW needs to set CMB attributes, e.g., Completion Queue Size (CQS) and Submission Queue Size (SQS) in CMBSZ, to appropriate values to ensure that CMB can be used correctly. If FW needs to set CQS and SQS in CMBSZ to 1 during initialization, it indicates that controller 12100 supports the establishment of Admin SQ/CQ and I/O SQ/CQ in CMB. If FW needs to set CQS and SQS in CMBSZ to 0 during initialization, it indicates that controller 12100 does not support the establishment of Admin SQ/CQ and I/O SQ/CQ in CMB. CMBLOC is to indicate the PCIe address range corresponding to CMB on the host 11000. When the controller 12100 turns on CMB and restarts the host 11000, the host 11000 enables the CMBLOC and CMBSZ registers, and the CMB function of the controller 12100 is enabled, the controller 12100 allocates a buffer region in the buffer 12130 as the CMB. In order to buffer log data in the CMB and ensure that the CMB is to buffer log data instead of establishing NVMe SQ and CQ, the FW needs to set the relevant properties (e.g., CQS and SQS in CMBSZ) to 0 during initialization. This is to tell the driver that the CMB is ready to store log data and is not used for other purposes.

In an example, taking buffering log data in CMB as an example, when the controller 12100 turns on CMB and restarts the host 11000, the host 11000 enables the CMBLOC and CMBSZ registers, and the CMB function of the controller 12100 is enabled, the controller 12100 allocates an internal memory buffer region as the CMB. For example, lspci-vv (lspci-vv is a standard tool in the Linux system that is to display detailed information about all PCIe bus devices in the system or all devices connected to the bus) may be used to observe that a region has been added to a PCIe, and meanwhile indicate that the starting address of the Region and the size of the Region. This part of information provides the range and size of the CMB mapping address. The 8 MB address space starting from 0x840000 has been allocated to the CMB. Then, this CMB in the memory device will be mapped to an address space in a PCI base address register (BAR) of the host 11000. The host 11000 may access the data in the CMB through this address range. When the host 11000 tries to access the memory system 12000, if the accessed PCIe address falls within the address range configured by the CMB, the SSD will convert the memory read and write request of the PCIe address into the read and write request of the CMB. The PCI BAR space is a part of the PCIe device configuration space, which is to describe the memory space mapped by the device memory. Each PCIe device may have multiple BARs, and each BAR corresponds to a storage space on the device. Once the CMB is mapped to the address space of any PCI BAR, the host 11000 may interact with the CMB by accessing this address.

In some examples, the host processor 11100 obtains the log data from the buffer 12130 of the controller 12100 according to the target address, the target address is the memory address of the log data in the buffer 12130. The log information is stored into the first memory 11200 and/or the second memory A.

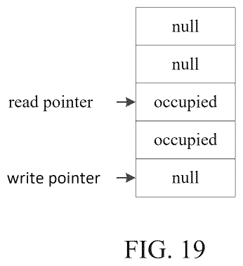

In some examples, because the CMB is a resource shared by the host 11000 and the FW, it is necessary to ensure that the host 11000 and the FW cannot read and write the same address in the CMB at any time. In order to avoid the problem that the host 11000 and the FW write to the same address of the CMB at the same time, the buffer in the CMB may be set to a logical Ring Buffer. Ring Buffer is a data structure that allows data producers (e.g., FW) and data consumers (e.g., host 11000) to write and read data at different locations without moving other data. As shown in FIG. 19, in the Ring Buffer, there are two key pointers: a write pointer (Write Position) and a read pointer (Read Position). The FW indicates that new data is written to the memory address (the memory address corresponds to the buffer in the CMB) by modifying the write pointer, and the host 11000 reads the written data by modifying the read pointer. The CMB includes a plurality of memory addresses, which are to indicate the location of writing and reading log data. At the same time, the same memory address is for at most one of writing log data and reading log data.

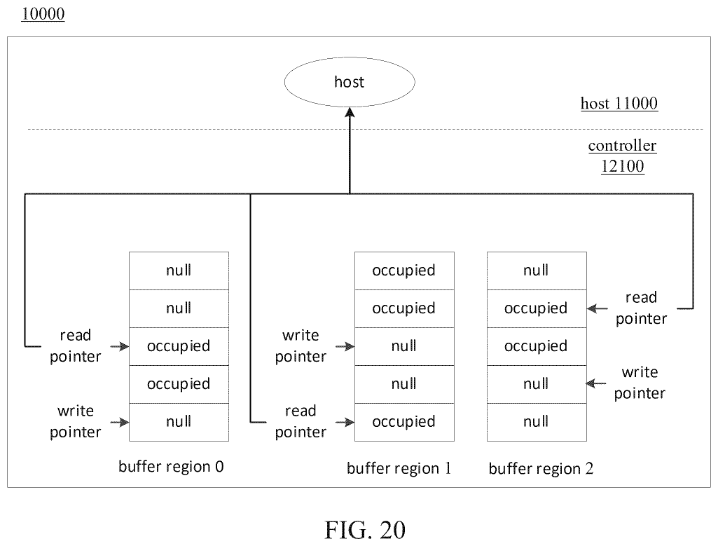

In an example, since most controllers 12100 include multiple cores, the multiple cores (e.g., Core 0, Core 1, and Core 2) buffer the log data generated during the running of the FW to the CMB. The allocation of CMB between the cores becomes particularly relevant, and different cores correspond to different buffer regions in the CMB. In order to ensure consistency and performance of the data, the buffer regions in CMB need to be allocated according to the architecture of FW. Taking the mirror core as an example (each core has the same function, is independent of each other, and can run FW in parallel), as shown in FIG. 20, CMB may be evenly allocated to each core for use. For example, CMB may be evenly divided into three buffers: buffer 0, buffer 1, and buffer 2. And buffer 0 may be allocated to core 0 for use, buffer 1 to core 1 for use, and buffer 2 to core 2 for use, which means that each core has its own CMB segment and interacts with the host 11000 through the respective Ring Buffer. This method can reduce contention and conflict between cores and improve the overall performance of the system. Each core uses the Ring Buffer to interact with the host 11000, as shown in FIG. 20, which includes the allocation of CMB, the structure of the Ring Buffer, and the interaction process between the host 11000 and the FW. The usage of the CMB Buffer and the Ring Buffer in a multi-core example of the controller 12100 is shown. In a non-mirrored Core scenario, the CMB may be allocated to each Core according to the function of each core, and the CMB buffer sizes allocated to at least two cores are different.

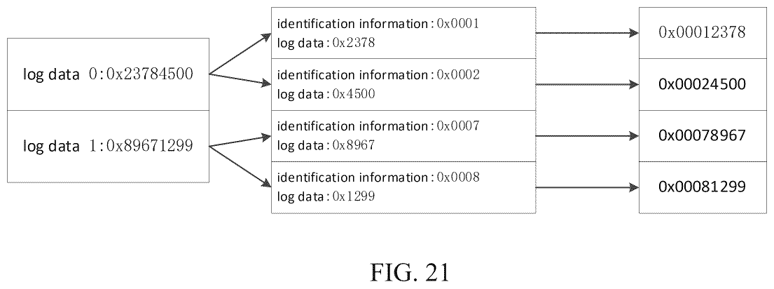

In an example, in order to minimize the size of the space occupied by a piece of log data, the FW may define the log information (Log Entry) structure according to the actual situation, Log Entry generally consists of identification information (Tag) and log data (Data), Tag is to indicate the bits occupied by Data. In order to ensure data alignment, the size may be defined as 32 bits or 64 bits. This can play a role in compressing the Log. As shown in FIG. 21, Log Entry being 32 bits is taken as an example. The upper 16 bits are Tag, and the lower 16 bits are data. Two 32-bit log data 0 (Data0) and log data 1 (Data1) need to be stored, with sizes of 0x23784500 and 0x89671299 respectively. In order to distinguish whether it is Data0 or Data1, Tag 0x0001 and Tag 0x0002 are used to represent the upper 16 bits and lower 16 bits of Data0 respectively. 0x0007 and 0x0008 are used to represent the upper 16 bits and lower 16 bits of Data1. Therefore, the data stored in the memory device is shown in FIG. 21, the organization of log information only requires one identification information and log data, which may reduce the size of log information storage space.

In some examples, NVMe SQ and CQ being established on PMR is taken as an example. PMR is also a buffer region provided by the controller 12100 for the host 11000 to use. The PMR space may provide a memory region with read and write speed at a memory level where data will not be lost after power failure. For example, the data can still be maintained when the power is turned off. There are at least two ways for maintaining data after power off, one way is to use SCM, e.g., non-volatile memory device such as PCM, FeRAM and NAND to implement PMR, which is mainly due to the non-volatile storage medium used by PMR. The second way is to allocate (part of) DRAM or (part of) SRAM in the memory system 12000 to the PMR, and the entire memory system 12000 is protected by the power-off protection design, by combining these two features, plus a certain amount of conventional NAND flash memory device, PMR may be implemented. For example, the memory system 12000 has special power-off protection capacitors, which can enable the data in the PMR to be safely refreshed to the flash memory device in the event of an unexpected power off. When the memory system 12000 is powered off, the content of the PMR will be automatically written to the flash memory, and when the host 11000 system is powered on again, the host 11000 can request the memory system 12000 to reload the content of the PMR. The way in which the PMR uses a queue and extracts log data is similar to that of the CMB, which will not be repeated here.

In this example, the CMB and the PMR allow the host 11000 to perform Direct Memory Access (DMA), treating it as an accessible buffer for read and write operations. The DMA technology enables the controller 12100 to directly transfer data with the host 11000 without the intervention of the controller processor 12120. Such a design significantly reduces the participation of the controller processor 12120 in the data transfer process, thereby greatly improving the speed and flexibility of data transfer, and also improving the performance of the entire system. Through this optimization strategy, the number of memory interactions between the memory system 12000 and the host 11000 is reduced, the data transfer process is optimized, and the system performance is significantly improved. This further improves the execution efficiency of tasks such as firmware debugging (FW debugging), performance analysis, and troubleshooting, therefore bringing users a better user experience.

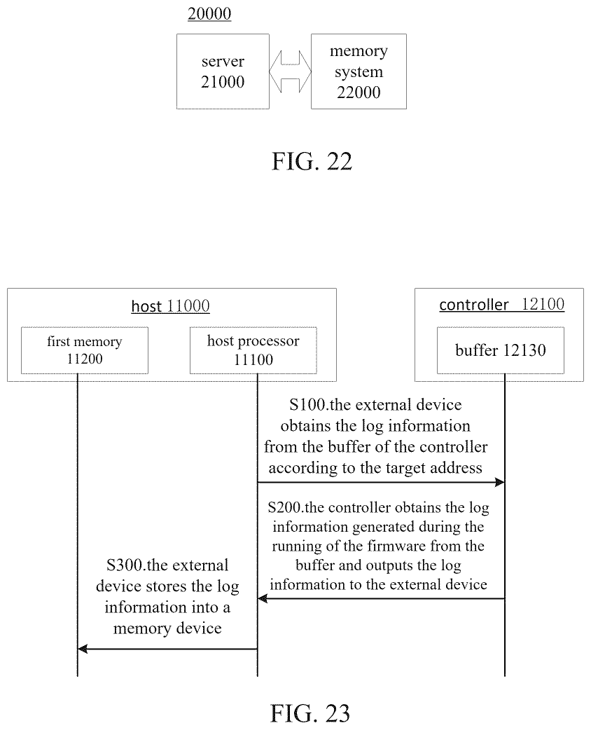

An example of the present disclosure provides a system, as shown in FIG. 22, the system 20000 includes a server 21000 and a memory system 22000 (e.g., the memory system 12000 described above), and the server 21000 is coupled to the memory system 22000. The server 21000 may include but is not limited to a cloud server, or may be the host 11000 as described above, which is not limited here. The cloud server is to store log information (including identification information and log data) and parse the log information to reproduce and locate the problem.

Based on the electronic device, host, memory system or controller shown in FIGS. 1, 2, 3, 4, 9, 10, 11, 12, 13, 14, 15, 16, 17, 18 and 20, the operating method including the following operations S100-S300 as shown in FIG. 23 may be implemented, and the operations include:

S100, the external device obtains the log information from the buffer of the controller according to the target address.

In some examples, the external device may include, but is not limited to, a host in the electronic device shown in FIGS. 1, 2, 3, 4, 9, 10, 11, 12, 13, 14, 15, 16, 17, 18, and 20, and may also include a server in the system shown in FIG. 22. The target address is the memory address of the log information in the buffer. As shown in FIG. 21, the log information includes identification information and log data information, the identification information is to indicate bits occupied by the log data. For details, please refer to the explanation of the example shown in FIG. 21 above, which will not be repeated here.

S200, the controller obtains the log information generated during the running of the firmware from the buffer and outputs the log information to the external device.

In some examples, in the examples shown in FIGS. 14, 15, 16, 17, 18, and 20, the buffer is configured to buffer log information generated during the running of the firmware. An external device, such as a host, may obtain log information from the buffer of the controller through the NVMe VU Command in the examples shown in FIGS. 14, 15 and 16, or through direct memory access to CMB or PMR in the examples shown in FIGS. 17, 18 and 20. The process may be referred to the explanation of the examples shown in FIGS. 14, 15, 16, 17, 18 and 20 described above, which will not be repeated here.

S300, the external device stores the log information into a memory device.

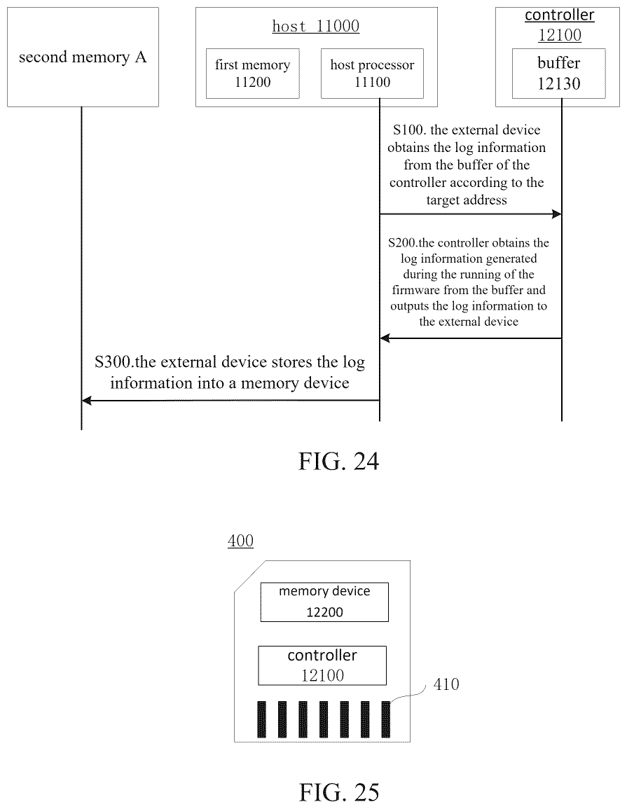

In some examples, as shown in FIG. 23, the log information may be stored in the first memory device shown in FIG. 15; or as shown in FIG. 24, the log information can be stored in the second memory shown in FIG. 16. The process may be referred to the explanation of the examples shown in FIGS. 15 and 16 described above, which will not be repeated here.

An example of the present disclosure provides a controller, a host, a method of operating a controller, and a method of operating a host. The method mainly involves temporarily storing the log information generated by the firmware into the buffer of the controller, and extracting the log information by the host through the high-speed interface circuit. In some examples, the log information is first temporarily stored in the buffer of the controller (e.g., SRAM or DRAM). It can avoid the accelerated wear of the memory device due to frequent writing of log information to the memory device, thereby shortening the service life of the entire memory system. Then, the host uses a command (e.g., NVMe VU Command) or mechanism (e.g., CMB or PMR mode) through a high-speed interface circuit (e.g., PCIe interface circuit) to extract the log information from the memory device of the controller. During the temporary storage process, the log information is first placed in the CMB (Common Management Block) or PMR (Persistent Memory Region). The size of the CMB or PMR is dynamically allocated by the controller according to the distribution of the buffer to ensure that the speed of the firmware when storing log data is not affected by the performance of the interface circuit. Once the log information is extracted, it can be stored into a first memory device inside the host (e.g., a built-in hard disk or SSD of the host), or a second memory external to the host (e.g., an externally connected hard disk or network storage). This storage method allows the size of log information to no longer be limited by the storage space of the controller itself, but depends on the storage space size of the memory device mounted on the host, thereby greatly increasing the amount of log information that can be stored, achieving the purpose of long-term storage of log information, and providing strong support for subsequent analysis and diagnosis.

An example of the present disclosure also provides a computer storage medium, the computer readable storage medium includes instructions. The instructions, when executed on the electronic device, host, memory system or controller described in the above example, cause the memory system to execute the data processing method described in the above example (e.g., the electronic device, host, memory system, controller and data processing method shown in FIGS. 1, 2, 3, 4, 9, 10, 11, 12, 13, 14, 15, 16, 17, 18, 20, 23 and 24).

The electronic device 10000 provided by the examples of the present disclosure as shown in FIG. 1, FIG. 2, FIG. 3, FIG. 4, FIG. 9, FIG. 10, FIG. 11, FIG. 12, FIG. 13, FIG. 14, FIG. 15, FIG. 16, FIG. 17, FIG. 18 and FIG. 20 may include but is not limited to mobile phone (e.g., cell phone), desktop computer, tablet computer, laptop computer, server, vehicle-mounted device, game console, printer, positioning device, wearable device (e.g., smart watch, smart bracelet, smart glasses, etc.), smart sensor, mobile power supply, Virtual Reality (VR) device, Augmented Reality (AR) device, or any other suitable electronic device having a memory device therein. The host 11000 in the electronic device 10000 may be a processor of the electronic device 10000, e.g., the processor may be a chip, in some examples a Field Programmable Gate Array (FPGA), an Application Specific Integrated Circuit (ASIC), a System on Chip (SoC), a Central Processor Unit (CPU), a Network Processor (NP), a digital signal processing circuit (Digital Signal Processor, DSP), a microcontroller (Micro Controller Unit, MCU), a Programmable Logic Device (PLD), an Application Processor (AP) or other integrated chips.

According to some implementations, the controller 12100 is coupled to memory device 12200 and host 11000 and is configured to control memory device 12200. The controller 12100 may manage data stored in the memory device 12200 and communicate with the host 11000. In some implementations, the controller 12100 is designed to operate in low duty cycle environments, e.g., Secure Digital (SD) card, Compact Flash (CF) card, Universal Serial Bus (USB) flash drive, or other media for use in electronic devices such as personal computer, digital camera, mobile phone, etc. In some implementations, the controller 12100 is designed to operate in high duty cycle environments e.g., Solid State Drive (SSD) or Embedded MultiMedia Card (eMMC), which is used as data storage for mobile electronic devices such as smartphone, tablet computer, personal computer, and enterprise storage array. The controller 12100 may be configured to manage data stored in the memory device 12200 and communicate with an external device (e.g., a host, in which a host is provided). Operations of the memory device 12200 are controlled, such as read, erase, and program operations. In some examples, the controller 12100 may also be configured to manage various functions related to data stored or to be stored in the memory device 12200, including but not limited to bad block management, garbage collection, logical to physical address conversion, wear leveling, etc. In some implementations, the controller 12100 is also configured to process error correction code (ECC) related to data read from or written into the memory device 12200. Any other suitable functions may also be performed by controller 12100, e.g., formatting the memory device 12200. The controller 12100 may communicate with external devices (e.g., host 11000) according to a particular communication protocol. For example, the controller 12100 may communicate with external devices through at least one of various interface protocols, such as USB protocol, MultiMedia Card (MMC) protocol, Peripheral Component Interconnect (PCI) protocol, PCI Express (PCI-E) protocol, Advanced Technology Attachment (ATA) protocol, Serial ATA protocol, Parallel ATA protocol, Small Computer System Interface (SCSI) protocol, Enhanced Small Drive Interface (ESDI) protocol, Integrated Device Electronics (IDE) protocol, Firewire protocol, etc.

Certainly, the controller 12100 may also perform any other suitable functions, e.g., formatting the memory device 12200. For example, the controller 12100 may communicate with an external device (e.g., host) through at least one of various interface protocols.

It is to be noted that interface protocol includes at least one of USB protocol, MMC protocol, Peripheral Component Interconnect (PCI) protocol, PCI Express (PCI-E) protocol, advanced Technology Attachment (ATA) protocol, Serial ATA protocol, Parallel ATA protocol, Small Computer Small Interface (SCSI) protocol, Enhanced Small Disk Interface (ESDI) protocol, Integrated Drive Electronics (IDE) protocol, Firewire protocol, etc.

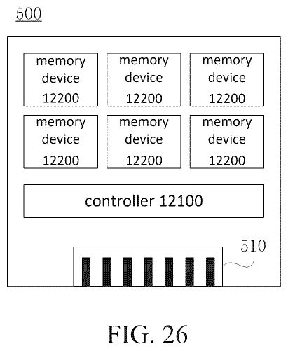

The controller 12100 and the one or more memory devices 12200 may be integrated into various types of memory systems, e.g., included in a same package, such as Embedded Multimedia Card (eMMC), Universal Flash Storage (UFS) package, Embedded Multi Chip Package (eMCP) package or UFS-based Multichip Package (uMCP) package. Among them, eMMC adopts a unified MMC standard interface to encapsulate high-density NAND and MMC controller in a Ball Grid Array (BGA) package chip. UFS is an advanced version of eMMC, which is also an array storage module composed of multiple flash memory chips and controllers. UFS makes up for the defect that eMMC only supports half-duplex operation (read and write must be performed separately), and may achieve full-duplex operation, so the performance may be doubled. eMCP formed by packaging a volatile memory such as Static Random-Access Memory (SRAM) or Dynamic Random-Access Memory (DRAM) packaged on eMMC. In some implementations, DRAM may be a Low Power Double Data Rate SDRAM (LPDDR). uMCP is formed by packaging volatile memory device (such as SRAM or DRAM) on UFS, which has high performance and large capacity. In some implementations, DRAM may be LPDDR. For example, the memory system 12000 may be implemented and packaged into different types of final electronic devices. In an example as shown in FIG. 25, the controller 12100 and the single memory device 12200 may be integrated into a memory card 400. The memory card 400 may include a PC card (PCMCIA, Personal Computer Memory Card International Association), CF card, Smart Media (SM) card, memory stick, multimedia card (MMC, RS-MMC, MMCmicro), SD card (SD, miniSD, microSD, SDHC), UFS, etc. Memory card 400 may further include a memory card connector 410 coupling the memory card 400 with a host (e.g., host 11000). In another example as shown in FIG. 26, the controller 12100 and multiple memory devices 12200 may be integrated into SSD500. SSD500 may further include an SSD connector 510 coupling the SSD500 with a host (e.g., host 11000). In some implementations, the storage capacity and/or operating speed of SSD500 is greater than the storage capacity and/or operating speed of memory card 400.

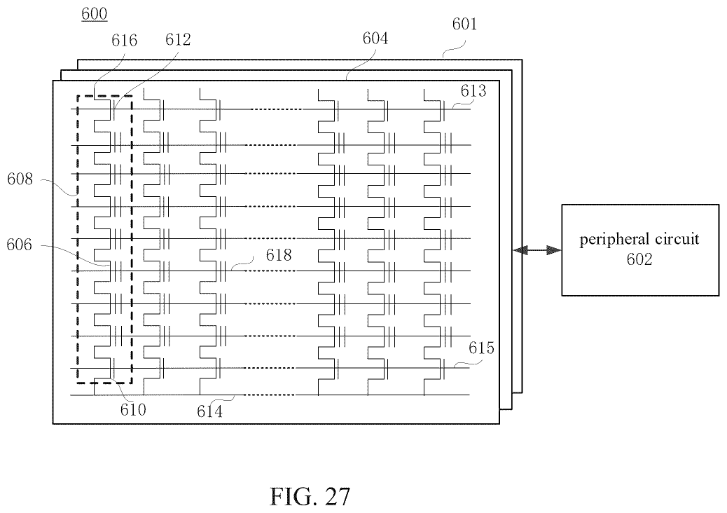

FIG. 27 illustrates a schematic circuit diagram of an example memory device 600 including peripheral circuit 602 according to some aspects of the present disclosure. The memory device 600 may be an example of the memory device 12200 in FIGS. 1, 2, 3, 4, 9, 10, 11, 12, 13, 14, 15, 16, 17, 18 and 20. The memory device 600 may include a memory cell array 601 and a peripheral circuit 602 coupled to the memory cell array 601. The memory cell array 601 may be a NAND flash memory cell array, where the memory cells 606 are provided in the form of an array of NAND memory strings 608 each extending vertically above a substrate (not shown). In some implementations, each NAND memory string 608 includes a plurality of memory cells 606 coupled in series and stacked vertically. Each memory cell 606 is able to retain a continuous analog value, e.g., voltage or charge, depending on the number of electrons trapped within the region of the memory cell 606. Each memory cell 606 may be a “floating gate” type memory cell including a floating gate transistor, or may be a “charge trap” type memory cell including a charge trap transistor.

In some implementations, each memory cell 606 is a Single-Level Cell (SLC) having two possible storage states (levels) and thus capable of storing one bit of data. For example, a first storage state “0” may correspond to a first range of threshold voltage, and a second storage state “1” may correspond to a second range of threshold voltage. In some examples, each memory cell 606 is an xLC capable of storing more than one bit of data in more than four storage states (levels). For example, xLC can store two bits in each cell (e.g., Multi-Level Cell, MLC), store three bits in each cell (e.g., Triple-Level Cell, TLC), or store four bits in each cell (e.g., Quad-Level Cell, QLC). Each xLC may be programmed to assume a range of possible nominal storage values (e.g., 2N segments of N-bit data, e.g., Gray code). In an example, an MLC may be programmed from an erase state to assuming one of three possible programming levels through writing one of the three possible nominal storage values into the cell. A fourth nominal storage value may be used for the erased state.

As shown in FIG. 27, each NAND memory string 608 may also include a Source Select Gate (SSG) transistor 610 at its source end and a Drain Select Gate (DSG) transistor 612 at its drain end. SSG transistor 610 and DSG transistor 612 may be configured to activate selected NAND memory string 608 (columns of the array) during read operation and program operation. In some implementations, sources of NAND memory strings 608 in the same block 604 are coupled through the same source line (SL) 614 (e.g., a common SL). In other words, according to some implementations, all NAND memory strings 608 in a same block 604 have an Array Common Source (ACS). According to some implementations, the drain of each NAND memory string 608 is coupled to a corresponding bit line 616 from which data can be read or written via an output bus (not shown). In some implementations, each NAND memory string 608 is configured to be selected or deselected through applying a select voltage or a deselect voltage to the gate of the corresponding DSG transistor 612 via one or more DSG lines 613 and/or to apply a select voltage or a deselect voltage to the gate of the corresponding SSG transistor 610 via one or more SSG lines 615.

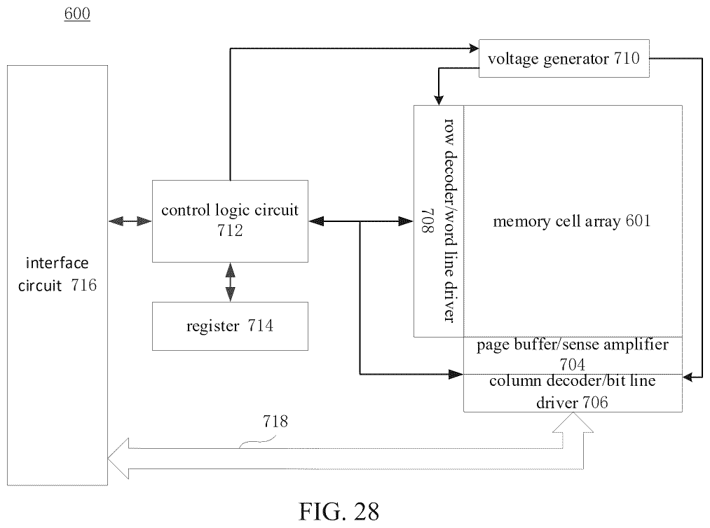

As shown in FIG. 27, NAND memory strings 608 may be organized into multiple blocks 604, each of which may have a common source line 614 e.g., coupled to an ACS. In some implementations, each block 604 is the basic data unit for an erase operation, e.g., all memory cells 606 on a same block 604 are erased simultaneously. To erase the memory cell 606 in the selected block 604, the source line 614 coupled to the selected block 604 and to the unselected blocks 604 in the same plane as the selected memory block 604 may be biased with an erase voltage (Vers) (e.g., a high positive bias voltage (e.g., 20V or higher)). Memory cells 606 of adjacent NAND memory strings 608 may be coupled through a Word Line (WL) 618 that selects which row of memory cells 406 is affected by read operation and program operation. The peripheral circuit 602 may be coupled to the memory cell array 601 through Bit Line (BL) 616, word line 618, source line 614, SSG line 615, and DSG line 613. The peripheral circuit 602 may include any suitable analog, digital, and mixed-signal circuitry for facilitating operation of the memory cell array 601 through applying a voltage signal and/or a current signal to and sensing voltage signal and/or current signal from each target memory cell 606 via bit line 616, word line 618, source line 614, SSG line 615, and DSG line 613. The peripheral circuit 602 may include various types of peripheral circuits formed with metal-oxide-semiconductor (MOS) technology. For example, FIG. 28 illustrates some example peripheral circuits, which includes page buffer/sense amplifier 704, column decoder/bit line driver 706, row decoder/word line driver 708, voltage generator 710, control logic unit 712, register 714, interface circuit (Interface, I/F) 716 (representing the interface circuit for communication between the controller 12100 and the memory device 12200) and data bus 718. Additional peripheral circuits not shown in FIG. 28 may also be included.

The page buffer/sense amplifier 704 may be configured to read data from and program (write) data to the memory cell array 601 according to control signals from the control logic unit 712. In an example, page buffer/sense amplifier 704 may perform a programming verify operation to ensure that data has been correctly programmed into memory cell 606 coupled to selected word line 618. In another example, page buffer/sense amplifier 704 may also, in the read operation, sense a low power signal from bit line 616 representing a data bit stored in memory cell 606 and amplify a small voltage swing to a recognizable logic level. As described in detailed below and consistent with the scope of the present disclosure, in a program operation, the page buffer/sense amplifier 704 may include a storage module (e.g., latch, buffer, register, etc.), which is to temporarily store a segment of N-bit data (e.g., in the form of Gray code) received from the data bus 718 and provide the segment of N-bit data to the corresponding target memory cell 606 through the corresponding bit line 616 in each programming pass of a multi-pass programming operation using a 2N-2N scheme.

Column decoder/bit line driver 706 may be configured to be controlled by control logic unit 712 and to select one or more NAND memory strings 608 through applying a bit line voltage generated from voltage generator 710. The row decoder/word line driver 708 may be configured to be controlled by control logic unit 712 and select/deselect block 604 of memory cell array 601 and select/deselect word line 618 of block 604. Row decoder/word line driver 708 may also be configured to drive word line 618 with a word line voltage generated from voltage generator 710. In some implementations, the row decoder/word line driver 708 may also select/deselect and drive the SSG line 615 and the DSG line 613. The voltage generator 710 may be configured to be controlled by the control logic unit 712, and generate word line voltage (e.g., read voltage, programming voltage, pass voltage, local voltage, verify voltage, etc.), bit line voltage and source line voltage to be supplied to the memory cell array 601.

Control logic unit 712 may be coupled to each of the peripheral circuits described above and configured to control operations of each of the peripheral circuits. Register 714 may be coupled to the control logic unit 712 and include status register, command register and address register for storing status information, command operation code (OP) and command address for controlling operations of each of the peripheral circuits. Interface circuit 716 may be coupled to control logic unit 712 and act as a control buffer to buffer control commands received from a host (e.g., the host 11000) and forward them to the control logic unit 712, and to buffer status information received from the control logic unit 712 and forward it to the host. Interface circuit 716 may also be coupled to column decoder/bit line driver 706 via data bus 718 and act as a data input/output (I/O) interface and data buffer to buffer and forward data to/from memory cell array 601.

The above is only specific implementations of the present disclosure, but the claimed scope of the present disclosure is not limited thereto, and changes or substitutions within the technical scope disclosed in the present disclosure that may be easily conceived by those skilled in the art shall fall within the claimed scope of the present disclosure. Therefore, the claimed scope of the present disclosure should be determined by the claimed scope of the claims.

What is claimed is:

1. A controller, comprising:
a controller processor;
a buffer configured to buffer log information generated during running of a firmware by the controller processor; and
an interface circuit coupled to the buffer and configured to:
obtain the log information generated during the running of the firmware from the buffer; and
output the log information to a host.

2. The controller of claim 1, wherein the interface circuit includes a Peripheral Component Interconnect Express (PCIe) interface circuit.

3. The controller of claim 1, wherein the buffer includes at least one of a volatile memory device and a non-volatile memory device.

4. The controller of claim 1, wherein the buffer includes at least one of a controller memory buffer (CMB) or a persistent memory region (PMR).

5. The controller of claim 4, wherein the CMB and the PMR comprise direct memory access regions.

6. The controller of claim 1, wherein the controller includes cores respectively coupled to the buffer and configured to: buffer the log information generated during the running of the firmware to the buffer.

7. The controller of claim 6, wherein different cores correspond respectively to different memory regions in the buffer, and wherein the cores are configured to buffer the log information generated during the running of the firmware to the corresponding memory regions.

8. The controller of claim 1, wherein the buffer includes of memory addresses, the memory addresses to indicate locations for writing and reading the log information, and wherein a same memory address is for one of writing the log information or reading the log information.

9. The controller of claim 1, wherein the controller processor is coupled to the interface circuit and the buffer and configured to:
output a control instruction in response to a log extraction request received from the host,
wherein the log extraction request includes information for a preset quantity of log information to be extracted, and the control instruction is to control the buffer to output log information with a quantity being less than or equal to the preset quantity.

10. The controller of claim 1, wherein the log information includes identification information and log data information, the identification information is to indicate bits occupied by log data.

11. The controller of claim 1, wherein the controller processor is configured to map at least a portion of first address spaces of the buffer to second address spaces of the host.

12. A host, comprising:
a memory device; and
a host processor coupled to the memory device and configured to:
obtain log information from a buffer of a controller according to a target address, wherein the target address is a memory address of the log information in the buffer, the host is coupled to the controller; and
store the log information in the memory device.

13. The host of claim 12, wherein the log information includes identification information and log data information, the identification information is to indicate bits occupied by log data;
the host processor is further configured to: obtain the log data according to the identification information and the log data information.

14. The host of claim 12, wherein the buffer includes at least one of a controller memory buffer (CMB) and a persistent memory region (PMR).

15. The host of claim 14, wherein the CMB and the PMR are direct memory access regions.

16. The host of claim 14, wherein at least a portion of first address spaces of the buffer is mapped to second address spaces of the host.

17. A method of operating a controller, comprising:
obtaining log information generated during running of a firmware from a buffer of the controller, wherein the log information generated during the running of the firmware by the controller is buffered in the buffer; and
outputting the log information to a host.

18. The method claim 17, wherein the controller includes cores, the method further includes: buffering, by the cores, the log information generated during the running of the firmware to the buffer.

19. The method of claim 18, wherein different cores correspond to different memory regions in
the buffer, and
wherein buffering, by the cores, the log information generated during the running of the firmware to the buffer includes:
buffering, by the cores, the log information generated during the running of the firmware to corresponding memory regions.

20. The method of claim 17, further includes:
outputting a control instruction in response to a log extraction request received from the host; wherein the log extraction request includes information for a preset quantity of log information to be extracted, and the control instruction is to control the buffer to output log information with a quantity being less than or equal to a preset quantity.
